(19) United States
(12) Patent Application Publication
(10) Pub. No.: US 2025/0014549 A1
(43) Pub. Date: Jan. 9, 2025

(54) Guitar Effect With Motion Activation

(71) Applicant: Bradford T Hite, Valencia, CA (US)

(72) Inventor: Bradford T Hite, Valencia, CA (US)

(21) Appl. No.: 18/349,130

(22) Filed: Jul. 8, 2023

(51) Int. Cl. G10H 1/053

(52) U.S. Cl. CPC G10H 1/053; G10H 2210/195

(57) ABSTRACT

A unique system for the implementation of an electric guitar effect activated by motion is fully integrated into the instrument. User control of the effect is implemented as either button/knob type controls or by solid state accelerometer-gyroscope sensors or both. The preferred embodiment describes an electronic pitch transposing effect similar to a mechanical “Whammy Bar” commonly found on electric guitars. The present invention incorporates user movement of the instrument as sensed by the accelerometer-gyroscope provides real time control of the effect. Other example of effects which could be implemented with the invention include: Wah-Wah, Flange, Phase Shifter, Tremolo or Echo.

### BACKGROUND OF THE INVENTION

### 1. Field of the Invention

This invention relates to the field of electric guitar effects integrated into the instrument. User control of the effects is implemented as either button/knob type controls or by solid state accelerometer-gyroscope sensors or both. The preferred embodiment describes an electronic pitch transposing effect similar to a mechanical “Whammy Bar” commonly found on electric guitars. The present invention incorporates user movement of the instrument as sensed by the accelerometer-gyroscope provides real time control of the effect.

### 2. Description of the Related Art

The electric guitar effect commonly referred to as either a “Vibrato Bar” or “Whammy Bar” comprises a mechanical means for changing the string tension. Fender in patent U.S. Pat. No. 2,741,146 (1956) titled “Tremolo Device for Stringed Instruments” describes a tremolo device incorporated in a novel bridge structure in order that the tension applied to the strings many be varied. The device is controlled by mechanical lever control arm the user pushes to change the string pitch. A similar pitch control for a steel pedal style guitar was patented by Lashley Et Al in U.S. Pat. No. 3,447,413 (1969) titled “Guitar Tone Changing Device”. This patent describes a set of mechanical foot pedals to vary string tension and change the musical pitch of each string. The pedals are fixed into the non-moving support structure of the horizontally mounted steel petal guitar.

The subject of motion activation of electrical guitar effects has been studied academically by mounting accelerometers on either the instrument or user. Willett in a 2008 paper titled “Motion-Based Control For Guitar Effects Processing” proposed an external accelerometer unit mounted on the end of the guitar neck. The accelerometer unit measures movement of the guitar neck and wirelessly transmits control information to an external effects rack. The effects within the rack can take as a control input the accelerometer sensed motion and modify the instrument sound. Control of such effects is described including: Distortion/Fuzz, Delay/Echo/Chorus, Pitch Shifter, and Auto-Wah. Another implementation of motion activation has been proposed by Hoye Et Al in a 2012 paper titled “Purdue students' device creates guitar ‘Wah’ effect without physical pedal”. In this implementation, an external sensor unit is mounted to the user's ankle to detect an angular displacement of movement. The resistive sensor information is transmitted wirelessly to an external effects rack whereby the ‘wah’ effect is controlled modifying the guitar sound.

### BRIEF SUMMARY OF THE INVENTION

The present invention comprises an electric guitar audio effect fully integrated into the instrument and controlled by gyroscope sensed motion. This integrated approach eliminates the need for external rack mounted or pedal effects commonly used by musicians. Common guitar control functionality for volume and tone are maintained while additional new dedicated controls associated with the guitar effect are added.

### BRIEF DESCRIPTION OF THE DRAWINGS

FIG. 1 is a system block diagram for the present invention.

FIG. 2 is a physical diagram of guitar player and coordinate system definition.

FIG. 3 is a software flow chart detailing the main routine process steps.

FIG. 4 is a software flow chart detailing the gyro control function process steps.

FIG. 5 is a software flow chart detailing the pitch control function process steps.

FIG. 6 is a schematic diagram of an example implementation of a preferred embodiment.

FIG. 7 is an electronic component datasheet showing Page 1 of the Murata SCC2230-E02 “Combined gyroscope and 3-axis accelerometer with digital SPI interface”.

FIG. 8 is an electronic component datasheet showing measurement axis and directions for the Murata SCC2230-E-02 gyroscope module.

### REFERENCE NUMERALS IN THE DRAWINGS

| | | | |
|---|---|---|---|
| 100 | Guitar Magnetic | 102 | Input Amplifier Gain |
| | Pickup | | Block |
| 104 | Processor | 106 | PWM Output Low Pass |
| | Executing Control | | Filter |
| | Software | | |
| 108 | Tone Control with | 110 | Volume Control with |
| | Adjustable Filter | | Gain Block |
| 112 | Discrete Type User | 114 | Accelerometer and |
| | Controls | | Gyroscope Module |
| 116 | Analog Type User | 118 | Output Signal Port to |
| | Controls | | External Amplifier |
| 120 | Control Software | | |
| | Executing on a | | |
| | Processor | | |
| 300 | Initialize Program | 302 | Initialize Hardware |
| | Variables Process | | Interfaces Process |
| | Step | | Step |
| 304 | Start Sub-Process | 306 | Power Down Decision |
| | Process Step | | Block |
| 308 | Sub-Process Step | 310 | Sub-Process Step for |
| | for Gyroscope | | Pitch Control Function |
| | Control Function | | |
| 400 | User Button | 402 | Read Gyroscope |
| | Activated Decision | | Angular Rate Process |
| | Block | | Step |
| 404 | Angular Rate | 406 | Angular Rate Less |
| | Greater Than Zero | | Than Zero Decision |
| | Decision Block | | Block |
| 408 | User Button | 410 | Command Pitch Up |
| | Deactivated | | Change Proportional to |
| | Decision Block | | Gyro Rate Process |
| | | | Step |
| 412 | Command Pitch | 414 | Periodic Wait Delay for |
| | Down Change | | Next Gyro Sample |
| | Proportional to | | Reading Process Step |
| | Gyro Rate Process | | |
| | Step | | |
| 416 | Send Updated | | |
| | Pitch Command to | | |
| | the Pitch Control | | |
| | Function Process | | |
| | Step | | |
| 500 | Initialize Hardware | 502 | Wait for Input Sample |
| | Timers to Control | | Timer Event Decision |
| | Sampling Process | | Block |
| | Step | | |
| 504 | Read Guitar | 506 | Store Input Sample into |
| | Analog Input | | Sample Circular Queue |
| | Process Step | | Process Step |
| 508 | Increment the | 510 | Receive Updated Pitch |
| | Input Sample | | Command from the |
| | Index Process | | Gyro Control Function |
| | Step | | Process Step |
| 512 | Update the | 514 | Wait for Output Sample |
| | Input Sample | | Timer Event Decision |
| | Timer for Next | | Block |
| | Iteration | | |
| | Process Step | | |
| 516 | Read Output | 518 | Interpolate the Output |
| | Samples from | | Samples Process Step |
| | Circular Queue | | |
| | Process Step | | |
| 520 | Write | 522 | Update the Output |
| | Interpolation | | Sample Timer for Next |
| | Result to PWM | | Iteration Process Step |
| | Output | | |
| | Modulator | | |
| | Process Step | | |
| 524 | Update the | | |
| | Output Sample | | |
| | Timer for Next | | |
| | Iteration | | |
| | Process Step | | |

### DETAILED DESCRIPTION OF THE INVENTION

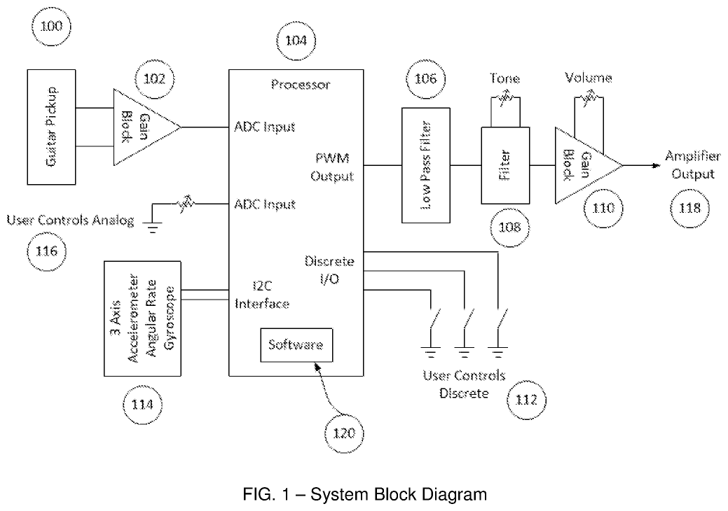

The preferred embodiment system block diagram of the present invention is shown in FIG. 1 as an electric guitar effect fully integrated into the instrument. In this preferred embodiment, the processor executing control software implements a pitch transposing effect similar to the previously described mechanical “Whammy Bar”. An electronics module can be integrated into an area within instrument body typically where existing electronics reside thereby requiring only minor modifications to the instrument. Guitar Pickup 100 magnetically detects string vibrations and sends the resulting audio signal to input Gain Block 102 for amplification. Gain Block 102 can provide any level of fixed gain including unity. The output of Gain Block 102 is input to Processor 104 analog to digital converter to digitize the audio signal. Processor 104 executes Software 120 to control hardware components and implement the guitar effect function. Examples of Processor 104 include but are not limited to a microcontroller or a microprocessor capable of executing software. Manual user controls available on the instrument are input to Processor 104 to interface with Software 120. These two types of controls are shown as User Controls Discrete 112 and User Controls Analog 116. Example discrete user controls can include but are not limited to: Push buttons, Rocker Switches, and Slide Switches. Similarly, example analog user control can include but are not limited to: Knobs, Capacitive/Resistive Touch Pads, and Linear Potentiometer. In this preferred embodiment, activation of a discrete control enables the guitar effect operation while deactivation disables the effect. Alternate embodiments can be implemented utilizing different methods to enable or disable the effect operation. Accelerometer-Gyroscope 114 is a self contained digital sensor outputting data to Processor 104 using a serial communications bus. In this preferred embodiment, Accelerometer-Gyroscope 114 sensor angular rotation rate data is used by the Software 120 to control the audio effect. An alternative method for controlling the audio effect would be to use an analog user control as the input. Modified audio signals created by Software 120 are output by Processor 104 using Pulse Width Modulation (PWM). An alternative output method to using PWM for signal generation could be a Digital to Analog converter. The PWM digital output waveform is converted to an analog DC level by Low Pass Filter 106. Commonly found instrument controls for volume and tone are implemented by blocks 108 and 110 respectively. Tone filter 108 can be implemented as either an active or passive electrical circuit with single or multiple user controls. Similarly, Gain Block 110 can be an electrically active or passive circuit with user volume control. The processed audio output signal is sourced to the Output 118 port serving as the instrument output.

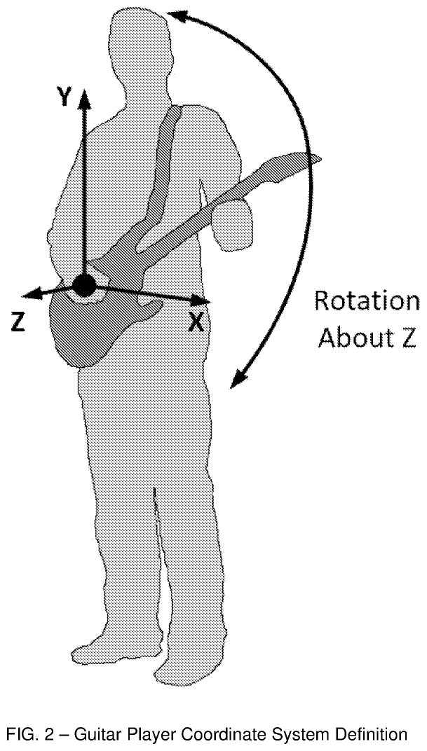

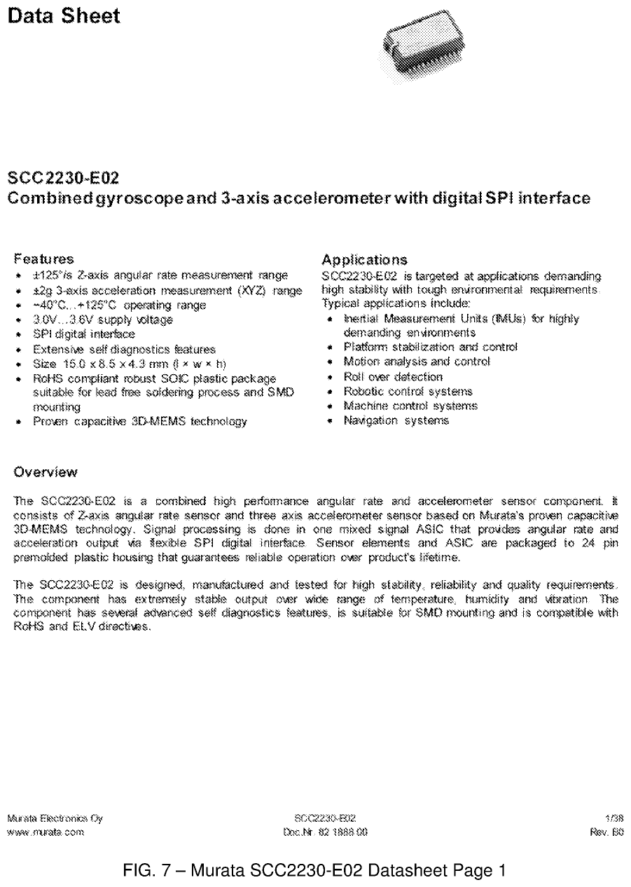

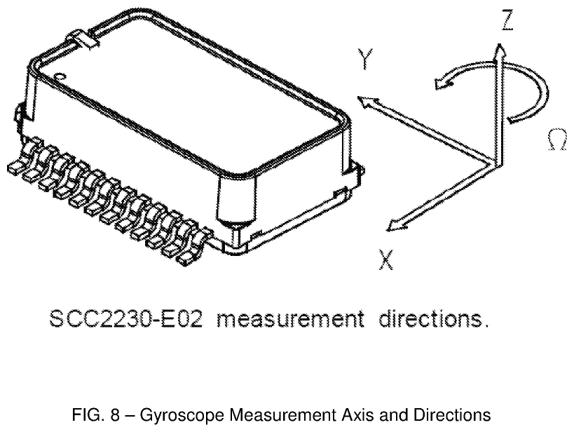

FIG. 2 shows a depiction of an electric guitar being played by a musician in the standing position. The origin of Cartesian coordinates X-Y-Z and an angular rotation about the Z axis are shown corresponding to linear accelerations and rotational rate sensed by Gyroscope 114. A matching depiction of this coordinate system can be seen in FIGS. 7 and 8 as defined for the Murata SCC2230-E02 combined gyroscope-3D accelerometer as mounted on a circuit card internal to the instrument body. While it would be possible to sense the instruments change in position using a downward gravity acceleration vector, the angular rotation about Z is directly sensed by the gyroscope. Physically, the angular rotation about Z corresponds to the instrument head stock being raised or lowered relative to the normal playing position.

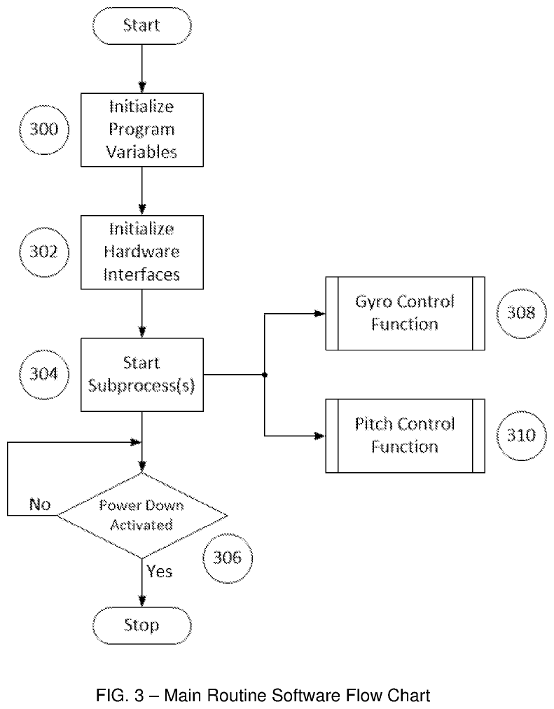

Software flowcharts describing the example operation of control Software 120 are shown in FIGS. 3, 4, and 5 as a set of process steps. Beginning with the Main Flowchart in FIG. 3, after power up the program variables and hardware interfaces are initialized in steps 300 and 302 respectively. Step 304 then starts up event driven sub-processes for Gyro Control 308 and Pitch Control 310. Sub-processes 308 and 310 run continuously based on events detected by the processor hardware. After the two sub-processes are started the main program waits for a power down command terminating software execution. Typically, a power down command can be activated by a User Discrete Control 112 or removal of operating power.

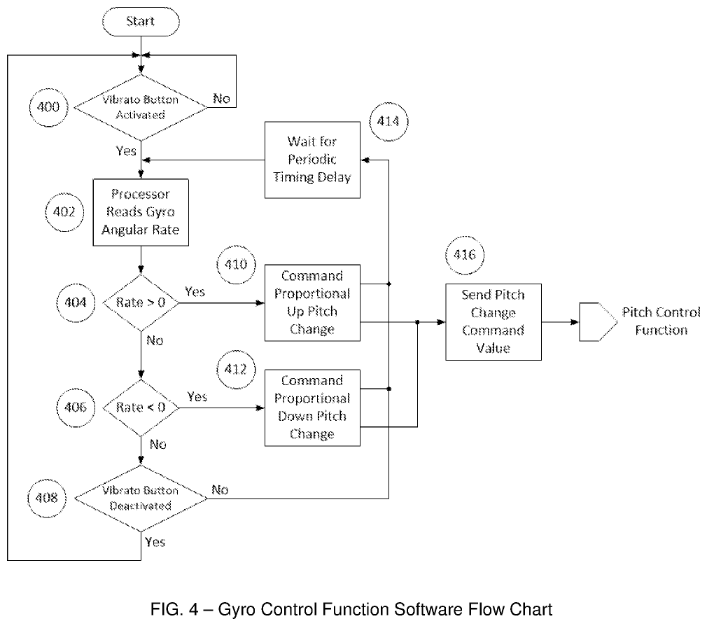

FIG. 4 details an example of control Software 120 operation for Gyroscope sampling and pitch command generation. Process activation 400 is initiated by a User Controls Discrete 112 event, for example as a “Vibrato Button” is pressed thereby starting the pitch transpose operation. Step 402 samples the gyro angular rate parameter using the serial communications interface. The angular rate is determined to be positive (up) or negative (down) by steps 404 and 406 respectively. In the event a positive rate is found, step 410 commands a proportional up pitch change to interface step 416. Similarly, in the case a negative rate is detected, process step 412 will command a proportional down pitch change to interface step 416. If both test Steps 404 and 406 fail indicating a zero angular rate, a test 408 is made for deactivation of the example “Vibrato Button” control. Upon deactivation of the control, the pitch control sequence is exited thereby returning to an inactive state. In the event either a pitch change command is generated or the “Vibrato Button” control remains active, execution flow transfers to timing delay Step 414. Time out of the delay period will proceed to another sampling of the Gyro angular rate parameter.

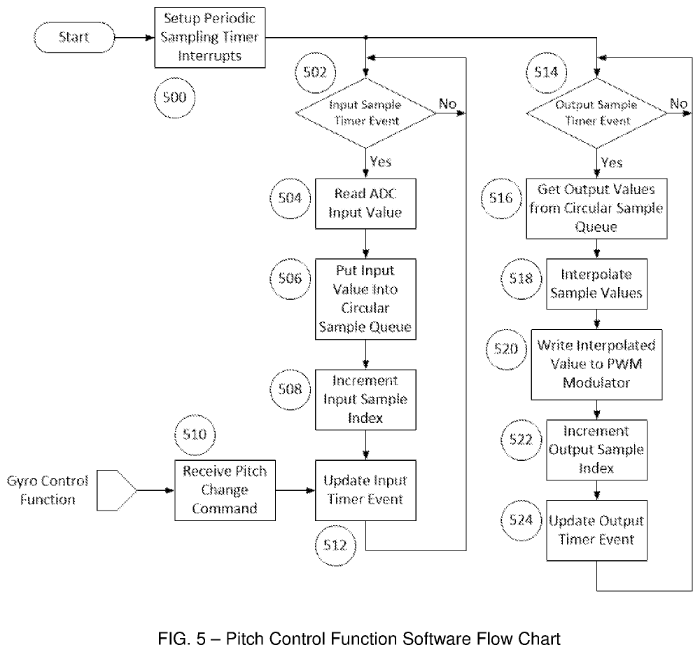

FIG. 5 details an example of control Software 120 operation for resampling of the instrument audio signal to create a pitch change. Initially, Step 500 initializes the input and output sampling timer periodic rates for normal operation. Input sample timer event 502 waits until the time out occurs and execution proceeds to input sampling. Step 504 reads the microcontroller ADC input thereby obtaining an audio sample stored in a circular queue by Step 506. After storage, Step 508 increments the circular queue write pointer to the next entry position. Interface 510 receives a pitch change command from interface 416 for input to Step 512 thereby modifying the input sampling periodic rate. Output sample timer event 514 waits until the time out occurs and execution proceeds to output sampling. Step 516 reads a group of sample values from the circular queue and Step 518 performs an interpolation to determine an output value. The interpolation calculation is used to smooth out any sharp discontinuities in the output audio signal thereby avoiding discernable clicks or pops. The interpolated value is then sent to PWM Step 520 for output to the hardware. Finally, Step 522 updates the output sample index to the next entry position and Step 524 updates the output sample rate. The output sample rate is constant based on the need to supply PWM 520 at a fixed rate.

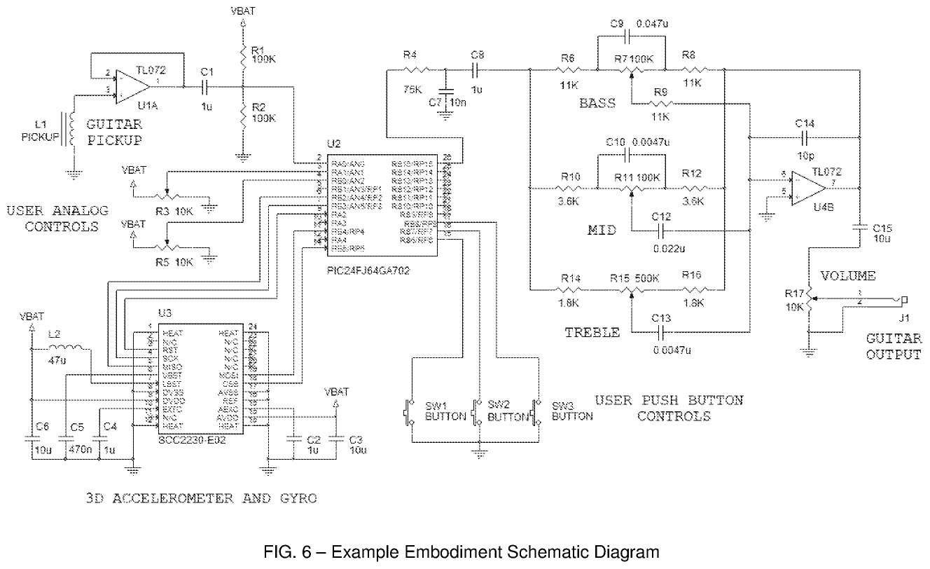

An example electrical schematic for the preferred embodiment is shown in FIG. 6. Description of the circuitry will reference FIG. 1 to associate system block functionality. Guitar pickup 100 is implemented by pickup inductor L1. Gain block 102 is implemented by amplifier U1A and supporting discrete parts. Processor 104 is implemented by U2. User Controls Analog 116 are implemented by potentiometers R3 and R5. Accelerometer-Gyroscope 114 is implemented by U3 and supporting discrete parts. Microcontroller 104 is implemented by U2. Low Pass Filter 106 is implemented by R4 and C7. Tone Filter 108 is implemented by potentiometers R7, R11 and R15 with supporting discrete parts. Volume Gain Block 110 is implemented by U4B and potentiometer R17. Amplifier Output 118 is implemented by connector J1. Finally, User Controls Discrete 112 is implemented by push button switches SW1, SW2, and SW3.

A first alternate embodiment of the present invention consists of the control software implementing a Wah-Wah effect.

A second alternate embodiment of the present invention consists of the control software implementing a flange effect.

A third alternate embodiment of the present invention consists of the control software implementing a phase shifter effect.

A fourth alternate embodiment of the present invention consists of the control software implementing a tremolo effect.

A fifth alternate embodiment of the present invention consists of the control software implementing an echo effect.

The claimed invention is:

1. A guitar effect with motion activation integrated into the instrument comprising:
a. a processor executing control software;
b. a gyroscope circuit coupled to the processor, the gyroscope circuit generating angular rate information in response to movement;
C. a set of discrete controls coupled to the processor, the discrete controls generating control information in response to user actions;
d. a tone control circuit coupled to the processor, the tone control circuit modifying the audio signal in response to user actions;
e. a volume control circuit coupled to the processor, the volume control circuit modifying the audio signal in response to user action;
f, wherein the processor is configured to receive an input audio signal and generate an output audio signal;
g, wherein the control software is configured receive angular rate information from the gyroscope circuit to control the audio effect; and
h, wherein the control software is configured to generate an audio effect by modification of an input audio signal to generate an output audio signal.

2. The system of claim 1, wherein the analog controls are used to control the guitar effect.

3. The system of claim 1, wherein the control software is configured to implement a pitch transposing effect.

4. The system of claim 1, wherein the control software is configured to implement a Wah-Wah effect.

5. The system of claim 1, wherein the control software is configured to implement a flange effect.

6. The system of claim 1, wherein the control software is configured to implement a phase shifter effect.

7. The system of claim 1, wherein the control software is configured to implement a tremolo effect.

8. The system of claim 1, wherein the control software is configured to implement an echo effect.

9. A method of controlling a guitar effect using motion activation integrated into the instrument comprising:
a. executing control software on a processor;
b. generating angular rate information by a gyroscope circuit in response to movement;
C. generating control information by a set of discrete controls in response to user actions;
d. modifying an audio signal by a tone control circuit in response to user actions;
e. modifying an audio signal by a volume control circuit in response to user action;
f. receiving an input audio signal by a processor;
g. generating an output audio signal by a processor;
h. controlling an audio effect by control software based on angular rate information received from a gyroscope circuit; and
i. generating an audio effect by modification of an input audio signal by control software to generate an output audio signal.

10. The method of claim 9, further comprising controlling a guitar effect by analog controls.

11. The method of claim 9, further comprising modifying an input audio signal by control software to implement a pitch transposing effect.

12. The method of claim 9, further comprising modifying an input audio signal by control software to implement a Wah-Wah effect.

13. The method of claim 9, further comprising modifying an input audio signal by control software to implement a flange effect.

14. The method of claim 9, further comprising modifying an input audio signal by control software to implement a phase shifter effect.

15. The method of claim 9, further comprising modifying an input audio signal by control software to implement a tremolo effect.

16. The method of claim 9, further comprising modifying an input audio signal by control software to implement an echo effect.
